(19) United States
(12) Patent Application Publication
(10) Pub. No.: US 2018/0345918 A1
(43) Pub. Date: Dec. 6, 2018

(54) SENSOR-CONTROLLED REDUCED WASHING AGENT CONSUMPTION IN CAR WASHING INSTALLATIONS

(71) Applicant: Washtec Holding GmbH, Augsburg (DE)

(72) Inventors: Oliver Foerg, Augsburg (DE); Bernhard Heinz, Gersthofen (DE)

(21) Appl. No.: 16/043,083

(22) Filed: Jul. 23, 2018

Related U.S. Application Data
(63) Continuation of application No. PCT/EP2017/051496, filed on Jan. 25, 2017.

(30) Foreign Application Priority Data
Jan. 28, 2016 (DE) 10 2016 101 481.8

(51) Int. Cl. B60S 3/06; G07F 17/20; G06Q 30/02

(52) U.S. Cl. CPC B60S 3/06; G06Q 30/0283; G07F 17/20

(57) ABSTRACT

A vehicle wash installation includes an electronic control unit for controlling a washing program of a vehicle. The installation further includes a sensor unit, via which a sensor signal is read-in and relayed to the control unit that calculates a control command. The control unit responds to a received sensor signal by calculating washing program sections and controls the vehicle washing installation with control logic. Washing program sections are displayed on a display on the input and output unit. A method and a computer program for controlling an in-bay car wash on the basis of automatically read sensor data from the sensor unit are also disclosed.

### CROSS REFERENCE TO RELATED APPLICATIONS

This application is a continuation application of international application PCT/EP2017/051496, filed Jan. 25, 2017, which claims priority to German patent application DE 10 2016 101 481.8, filed on Jan. 28, 2016, both of which are hereby incorporated by reference in their entireties.

### TECHNICAL FIELD

The present disclosure relates to a portal vehicle washing installation, a control unit for the vehicle washing installation, and to a method and a program for controlling a portal vehicle washing installation in an environmentally friendly and energy-saving manner.

### BACKGROUND

In the related art, it is known to provide sensors to configure the washing procedure in a reliable manner. For instance, WO 2003/070531 A1 discloses a method of monitoring the work area of a movable portal of the washing installation via sensors to be able to automatically interrupt the washing procedure, e.g., when people enter the installation. However, the washing procedure per se is not influenced by the signals detected by the sensors. Furthermore, the sensor signals in the related art are not used for controlling the washing process in terms of process engineering.

It is also known in the related art to provide the user with pre-configured washing program modules (e.g., fast wash, wash including pre-wash, etc.) for selection. These pre-configured washing program sections are associated with a fixedly defined control sequence. This washing installation is then controlled and operated by this control sequence. Therefore, to determine the washing program, the user has hitherto been offered only pre-defined program modules on a user interface. Therefore, by reason of the pre-definition or the fixed wiring of the program modules, they cannot necessarily be modified in the related art. However, it has been shown in practice that more flexibility is desired in this regard. In particular, it should be possible to provide washing installation control and washing installation operation which is adapted to the current specific situation.

Tests have also shown that it is desirable to give the user more opportunity to influence the washing procedure. In particular, it has proven to be disadvantageous that the current situation or the respective condition of the vehicle (e.g., the level of dirt) and the ambient conditions (e.g., humidity, temperature) cannot be taken into consideration when configuring the vehicle washing program. In the case of the related art systems, the washing procedure thus could not be altered or adapted on the basis of the current state. For instance, it makes little sense, e.g., to have a drying procedure, which takes place after the washing procedure, if it is raining. Therefore, in the case of the related art systems it proves to be disadvantageous that a vehicle washing program can be controlled only on the basis of fixedly pre-defined and non-variable washing program sections.

### SUMMARY

It is an object of the present disclosure to improve the operation of automatic vehicle washing installations and, in particular, to control them in a more flexible manner. If a vehicle is only slightly dirty, it should be possible to automatically recognize this situation and provide the user with situation-specific washing program sections for selection, thus making it possible to use washing agent substances or cleaning substances in a targeted manner and reduced quantity where possible. Furthermore, greater flexibility should be provided when the washing procedure is being configured by the user, thus making it possible to be able to activate an individualised wash on the basis of a currently determined state and to offer, e.g., an option in order to reduce the resource and/or energy requirement for the washing procedure.

In accordance with the disclosure, this object is achieved by means of a vehicle washing installation, a control unit, and a method as well as a computer program product as disclosed herein.

The disclosure is described hereinafter with the aid of the solution involving a device, and therefore with the aid of the control unit. Features, advantages, or alternative embodiments mentioned therein are likewise applicable to the disclosed method or computer program, and vice versa. In other words, the subject matter described, e.g., for a washing installation or to a control unit, can also be applied with the features described in conjunction with the method or computer program. In so doing, the corresponding functional features of the method or computer program are embodied by corresponding modules of the installation, in particular, by electronic circuitry components or microprocessor modules of the devices and vice versa.

According to an aspect, the disclosure relates to a control unit for activating a vehicle washing installation, wherein the control unit exchanges data with an input and output unit which functions as a user interface and is intended to display a host of selectable washing program sections and for detecting a selection of at least one of the displayed washing program sections. The control unit is configured to calculate control commands for activating the vehicle washing installation from the detected selection (of washing program sections). In accordance with the disclosure, the control unit exchanges data with a sensor unit to receive sensor signals from the sensor unit. The control unit is intended to configure and calculate washing program sections as it were on the basis of the received sensor signals in an application-specific manner and in response to the detected sensor signals and sensor data. The calculated washing program sections are then displayed on the input and output unit for the purpose of selection by the user. Then, by reason of the detected selection signals which define the user-selected washing program sections, control commands are generated and are transmitted to the vehicle washing installation for control purposes.

The present disclosure thus relates to a situational and dynamic control of a washing installation, based upon currently detected sensor data, ambient conditions, and/or based upon customer specifications (configurations). The individual machine components of the vehicle washing installation or the respective units of the vehicle washing installation (e.g., the washing portal itself, spray nozzle units, rinsing units, drying units, etc.) can be activated in a modular and dedicated manner in dependence upon the sensor data and/or configurations (which can be generated from configuration data which the user can input via a user interface provided).

The disclosure has several advantages. For instance, it firstly becomes possible to configure individualised washing program sections for the respective current case on the basis of sensor signals and to combine these to form a washing program. Users can be offered a tailored vehicle wash which is customised specifically for them, and moreover not only on the basis of fixed, pre-defined washing programs, but also on the basis of individualised and currently and specifically configured washing program sections. In accordance with the disclosure, the individual washing program sections can be configured in a situational manner. Furthermore, the resource requirement necessary for the washing procedure can be reduced considerably and, in particular, not only in terms of the metering of cleaning agents to be applied, but also in terms of the overall energy requirement. For example, the drying of the vehicle after the washing procedure requires a lot of energy. However, the drying procedure can be omitted if the sensor unit has detected that air humidity exceeds a pre-definable threshold value or precipitation.

The disclosure will be described hereinafter for a portal washing installation. The washing installation thus comprises a mobile portal support having a washing portal. In advance, users operate a user interface and configures his washing program specifically and in a situational manner in dependence upon ambient conditions and their specifications. To clean the vehicle, provision is made that the vehicle driver leaves the vehicle during the cleaning procedure so that the selected washing program can be performed on different units of the vehicle washing installation. To this end, the washing portal is moved with its units relative to the vehicle for cleaning purposes. However, it is readily understood by a person skilled in the art that the disclosure can likewise be applied or transferred to other washing facilities, such as, tunnel washing facilities, which are controlled via electronics components and on the basis of user inputs. In contrast to the portal washing facilities, the driver remains in the vehicle during the cleaning procedure in a tunnel washing installation and informs the member of staff at the tunnel washing installation which washing program is desired.

The control unit is an electronic unit which can be embodied in hardware as an integrated circuit (e.g., as a field-programmable gate array (FPGA)) or in software. The control unit serves to activate the washing installation. The control unit can be implemented directly in a component of the washing installation or indirectly on a processor unit which exchanges data with the washing installation. The control unit in accordance with the disclosure exchanges data with the sensor unit. Typically, data is exchanged with a unidirectional data connection, via which the sensor unit sends detected sensor data to the control unit. The sensor data represent a state of the vehicle to be cleaned, parts thereof, and/or technical washing conditions or a washing environment, such as, air humidity, temperature, or environmental protection requirements, etc. The sensor data are converted by means of control logic of the control unit into control commands for state-dependent activation of the washing installation with specifically generated washing program sections to be output and selected on a user interface.

The control logic is a circuit and/or a program which determines how the sensor data which can originate from the different sensors are calculated and which washing program sections are to be generated in each case on the basis of the detected sensor signals and/or sensor data.

The sensor unit comprises a plurality of sensor modules. For their part, the sensor modules comprise a plurality of sensors. The sensor modules can be fastened in a stationary and permanent manner to at least one component or temporarily (e.g., to the vehicle). The sensor modules and/or the sensors are typically provided at different positions. The sensors and/or the sensor modules can be installed at the washing installation itself, on components of the washing installation, and/or at the respective interfaces between the component and washing installation. However, the sensors and/or the sensor modules are typically not arranged on the washing installation or the components thereof, but instead are arranged externally of the washing installation. Therefore, they are located outside the washing installation. The sensors and/or the sensor modules can be formed temporarily on the vehicle to be cleaned and/or on an operating terminal. Furthermore, in an exemplary embodiment of the disclosure, the sensor module is designed having a receiving unit which serves to read in sensor data from external signal transducers or external (e.g., central) servers. For instance, the sensor unit can be designed to detect weather data from a server of a weather service. This can be current local weather data at the geographical position of the washing location as well as forecast data. The geographical position can be detected automatically via GPS sensors and/or via location-based services. The sensors are typically installed as sensors of different sensor types and also include, in addition to optical sensors, acoustic sensors, humidity sensors, position and/or proximity sensors, temperature sensors, Hall effect sensors, and other sensor types, switches, buttons, and/or potentiometers, etc.

The sensors serve to detect analogue and/or digital signals. The detected signals can be discrete measurement values (e.g., temperature) or continuous sensor signals (e.g., temperature profile over time).

In an exemplary embodiment of the disclosure, the sensor unit serves at the same time to detect input signals of the user on the user interface, wherein the detected input signals include a host of configuration settings of the user (e.g., configurations regarding the exposure time of a cleaning agent for a washing unit from the host of washing units, regarding the selection of the cleaning agents, regarding the process technology-related application (e.g., in foamed form or non-foamed form) regarding energy consumption etc.). Sensor data detected, e.g., via an external sensor unit can be displayed on the user interface and confirmed by a user input.

The entirety of all of the sensor signals represents a washing state. In accordance with the disclosure, it is possible to configure in advance which sensor signals are to be taken into consideration for calculating the washing state (e.g., it is not necessary to detect and take into consideration the temperature if the temperature is always constant). The washing state includes a state of the vehicle (e.g., the amount of dirt or moisture on the surface) and/or a state of the washing operation environment (temperature, air humidity, etc.). Therefore, the washing state is a multi-dimensional vector of different technical parameters or state variables.

The washing program sections include processes of the cleaning procedure, which can be performed sequentially or in parallel on different working units (also referred to hereinafter as unit or washing unit) or on operating resources of the washing installation. The washing program sections are thus a collection of different cleaning program modules or cleaning steps which can be combined to produce a washing procedure, e.g.:

a wheel rim wash using configurable cleaning agent(s),

insect cleaning with a configurable exposure time of the likewise configurable insect cleaning agent,

a polish using a configurable or selectable polishing agent,

an underside wash at a configurable intensity,

an upper side wash at a configurable intensity,

a contactless pre-wash with water or other media in a configurable quality, duration and/or configurable energy consumption,

an exposure time of a cleaning agent which can be configured to a selectable value,

a duration of a washing step which can be configured to a selectable value,

a duration of the entire washing procedure which can be configured to a selectable value,

surface sealing using a selectable sealant,

a deactivated drying procedure,

a drying time which can be configured to a selectable value, and/or

a fan output, which can be configured to a selectable value, during the drying procedure etc.

The respective configurations can be detected via selection signals on the user interface. For this purpose, configuration menus for selecting specific configurations can be output, from which the user can then select one or more of the configurations offered. Alternatively, the selection can also be performed automatically on the basis of detected sensor signals.

In other words, in accordance with the disclosure, the user can determine, by means of his input and settings or specifications, the working units which are actually operated for the wash and how these working units are operated (how long, at which pressure, at which temperature, at which cleaning agent concentration, etc.).

In accordance with the disclosure, the washing program sections are no longer pre-configured (e.g., “fast wash”, “intensive wash,” “with pre-wash”) but instead the users can configure the sections themselves. To do this, the users are offered on the user interface configuration settings for selection in the form of selection menus, e.g., for setting the exposure time of a cleaning agent or care product and/or the duration and/or intensity of the washing program section, etc. A selected washing program section can also be selected multiple times so that it is used in succession. Then, on the basis of the selected configuration settings (e.g., long exposure time, slow portal advancing speed, high-quality products) the specifically configured washing program sections (e.g., “intensive wash—high quality”) are calculated in a manner adapted to the situation and are output on the user interface. After display of the configured washing program sections on the user interface, the user can input selection signals which then, in turn, are converted into control commands to specifically activate the washing installation.

The input and output unit functions as a user interface. It can be installed in an operating terminal or can exchange data therewith. Typically, the unit is a graphical user interface. However, alternatively or cumulatively other types of interface can also be used, e.g., an acoustic interface which renders it possible for the user to effect inputs using spoken commands. When using a graphical user interface, it is possible to use e.g., a capacitive touch-screen. Typically, the touch-screen has a multi-sensor functionality so that simultaneous touches can also be detected. Also typically, the touch-screen comprises, in addition to the display (the actual display unit), a touch-screen sensor as an input unit for user signals, a controller, and optionally a driver which can be arranged in the operating terminal. In an alternative and likewise typical exemplary embodiment of the disclosure, the touch-screen sensor can be designed as a projected capacitive sensor (“PCT—projected capacitive touch”). The sensor thus uses two planes with a conductive pattern (e.g., stripes or lozenges). The planes are provided in a manner insulated from one another. If a finger is located on the crossing-point of two stripes, the capacitance of the capacitor changes and a greater signal arrives at the receiver stripe. This signal change can therefore be precisely measured with the aid of the X and Y coordinates, wherein a plurality of touch points can also be defined exactly. The current flow from the corners of the touch-screen to the touch point is proportional to the XY coordinates. The substantial advantage of this system is that the sensor can be attached to the rear side of the cover glass since the touch recognition is “projected through” the glass. Operation thus takes place on the practically wear-free glass surface. Furthermore, it is possible to recognise gestures and multiple touches (i.e., multi-touch). In other embodiments of the disclosure, however, resistive or inductive or other sensor technologies can also be used for the user interface of the operating terminal. The user interface (also referred to as a monitor) is used for outputting washing program sections which have been generated on the basis of the sensor data. The users can specify their displayed washing program sections according to their wishes, and can select them by inputting at least one selection signal. The users can also select a plurality of the displayed washing program sections. The selection includes at least one, typically a plurality of, washing program sections. The user interface can also display a menu which is generated specifically and in an individualised manner for the application and with the aid of which the user is guided through the process for generating his washing program. The user can also be provided with additional information (e.g., how much energy is required for the steps already selected and/or how much the selected washing program will cost).

In an exemplary embodiment of the disclosure, the control logic of the control unit is designed to ascertain, from the received sensor signals, a state, the washing state and to compare this with a reference state stored in a memory to perform a state-dependent calculation of the washing program sections. The comparison with reference values which can be stored in a central database ensures that the control task can be performed in an accelerated manner.

According to an exemplary embodiment of the disclosure, the control logic comprises an optimization module which optimizes the calculated washing program sections in terms of metering of cleaning agents, water consumption and/or in terms of energy consumption. Optionally, in advance it is possible to configure that in this case other optimization criteria can also be taken into consideration, such as e.g., optimization in terms of the cost and/or duration of the washing procedure etc. In accordance with the disclosure, the control module can generate state-specific suggestions for optimization. In an exemplary embodiment of the disclosure, the optimization criteria can be configured in advance—in a definition phase for configuring the control unit. To avoid inconsistent and conflicting inputs, in an exemplary embodiment of the disclosure provision can be made to check the inputs performed by the user for consistency and optionally to offer suggested corrections and to demand corrected inputs if the user selects, e.g., that a fast wash is to be performed with low energy consumption and in a short time. A warning containing further information can also be output on the user interface. Additional information relating to the consequences associated with the user's selection can also be output, e.g., relating to the costs incurred by the user's selection or the time associated with the selection of the washing program sections and/or the energy consumption. Then, on the basis of these data, a correction option is provided on the user interface, by means of which the user can revise the previous inputs.

According to a exemplary embodiment embodiment of the disclosure, the control logic comprises a configuration module which configures the calculated washing program sections in terms of specifiable and user-individual criteria. In this case, it is possible, e.g., to define that a user X in a vehicle Y would always like to have a specific washing procedure performed and/or that the user would always like to have the washing procedure optimized in terms of reduced consumption of water and energy resources. These user-specific settings are stored in a memory and can thus be retrieved for confirmation for subsequent washing procedures for the same user X and/or the same vehicle Y. The memory can be a mobile memory in the form of a transponder card or a stationary memory, e.g., in the form of a database.

According to a further exemplary embodiment embodiment of the disclosure, the sensor unit—as mentioned above—comprises a plurality of sensors which detect different physical measurement values of a vehicle and/or a washing environment, in particular a temperature sensor, a time sensor (e.g., in the form of a clock), an air humidity sensor, a sensor for detecting a vehicle size and/or the amount of dirt on a vehicle. In an alternative embodiment, a touch-key or other input field can also be provided on the user interface, via which the user manually confirms the data detected automatically by the sensor or directly inputs the data. The sensor unit generally has at least one and typically a plurality of sensors on different components and/or positions in general and also typically outside the vehicle washing installation. The sensor unit can also exchange data with external sensors (e.g., on the vehicle and/or on a remote server, such as a weather station).

The above-described activation of a vehicle washing installation is more complex because a multiplicity of sensor data is taken into consideration. Therefore, provision is made that the sensor signal-based control function can be selectively activated and deactivated by means of a sensor switch. When it is deactivated, the control is performed on the basis of pre-configured program modules and not on the basis of sensor data.

According to another aspect, the disclosure relates to a vehicle washing installation which is controlled by means of a sensor unit in conjunction with an input and output unit, comprising the following data-exchanging modules:

a control unit, as described above;

the input and output unit, on which in order to control the vehicle washing installation the dynamically calculated, state-dependent washing program sections are output for selection; and

a sensor unit which is configured to automatically detect sensor signals and to relay them to the control unit for calculating the control commands.

As described above, the individual units are electronic modules which exchange data via a suitable communications channel, Typically via a wireless network connection or via a mobile network, Bluetooth, or an NFC interface. Of course, the units can also be connected to a central server or a database, e.g., via a WLAN, LAN, or other suitable connection.

According to another aspect, the disclosure relates to a method of activating a vehicle washing installation, comprising the method steps of:

detecting sensor signals and/or configurations, from which a washing state is calculated,

calculating washing program sections in response to the calculated washing state and/or in response to the detected sensor signals,

relaying the calculated washing program sections for display on a user interface (Typically the input and output unit),

reading-in the selection signals detected on the user interface for selection of one of the displayed washing program sections, and

generating control commands for activating the vehicle washing installation on the basis of the detected selection signals.

In addition, on the user interface it is possible to detect not only the selection signals of the user but also configuration settings and/or optimization criteria for a washing process of the vehicle washing installation (e.g., comprising: configuration of washing agent consumption, energy consumption, setting of the time required for the washing process, and/or setting the costs of the washing process). The control commands are then generated on the basis of the detected selection signals, optimization criteria and/or configuration settings.

The input and output unit can display a graphical illustration (e.g., by outputting an instruction field with additional information) in response to the detected sensor signals.

Furthermore, an output field can be provided on the user interface, on which the detected sensor data are displayed. In one development of the disclosure, a confirmation field can be output, by means of which the user can confirm or dismiss that the detected sensor data (e.g., relating to the amount of dirt) are to be calculated in each case for calculating and configuring the washing program sections.

In an exemplary embodiment of the disclosure, the executed control commands are also maintained during operation of the vehicle washing installation and are fed to a calculation unit (or a processor of the control unit). The calculation unit can trigger further measures, inter alia, the automatic calculation of the costs of the washing process and the relaying of this cost data record to an output unit. The cost data record can also be relayed to a separate accounting organization so that payment can be affected after the washing procedure.

The executed control commands are also stored in a memory to be usable for subsequent calculations. This has the advantage that, if required, the user can repeatedly access his specific washing program which is configured according to his or her specifications. To this end, a database stores an allocation between the user or a data record which identifies the user (e.g., a biunique mobile communications identifier which is allocated to the user, e.g., an IMSI etc.) and the generated control commands and/or his or her selection signals.

An important technical advantage of the solution in accordance with the disclosure can be seen in the fact that the individual units, which are each installed in the portal washing installation, can be specifically activated. This can also be affected based upon software, by, e.g., the user configuring that a specific cleaning agent composition (washing agent paste) is to be used for the wash. For instance, it is also possible to determine how much water in which quality and at which temperature is to be added, to be able to define and perform a wash which is as environmentally sound as possible.

This object is further achieved by a computer program product which is, or can be, loaded into a memory of a computer or of an electronic unit, with a computer program to carry out the method described in more detail above, when the computer program is executed on the computer or the electronic unit.

This object is further achieved by a computer program for carrying out all of the method steps of the method described in more detail above when the computer program is executed on a computer or an electronic apparatus. It is thus also possible for the computer program to be stored on a medium which can be read by the computer or the electronic apparatus.

### BRIEF DESCRIPTION OF THE DRAWINGS

The disclosure will now be described with reference to the drawings, wherein:

FIG. 1 shows a schematic overview of a vehicle washing installation which is controlled by means of a control unit in accordance with the disclosure;

FIG. 2 is a schematic view of a control unit in accordance with the disclosure exchanging data with a sensor unit and an input and output unit; and

FIG. 3 is a flow diagram according to a preferred embodiment of the disclosure.

### DESCRIPTION OF EXEMPLARY EMBODIMENTS

The disclosure will be described in more detail hereinafter with the aid of exemplary embodiments in conjunction with the figures.

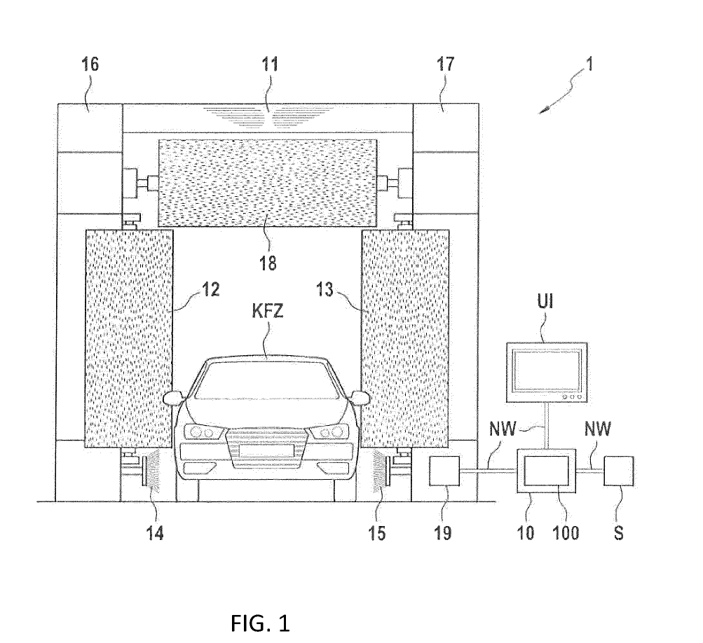

The disclosure relates to the sensor-triggered control of a vehicle washing installation 1 which is configured as a portal washing installation and is schematically illustrated in FIG. 1.

FIG. 1 shows a schematic front view of a portal washing installation 1 comprising different structural units, such as a washing portal with two vertical portal supports 16, 17, between which the vehicle KFZ to be washed is advanced through during the wash. The vertical portal supports 16, 17 each support two substantially likewise vertically oriented washing brushes 12, 13. Arranged in the upper region of the washing portal is a horizontal holding cross beam 11 having a horizontal roof washing brush 18. Wheel rim washing brushes 14, 15 can be arranged on the right and left in the lower region of the washing portal. The washing brushes 12, 13, 14, 15, 18 can be rotationally driven and are activated by means of a control unit 10. However, the embodiment of the disclosure illustrated in FIG. 1 is to be understood only as an example. It is readily understood by the person skilled in the art that fewer or even further, additional washing brushes and/or washing units (e.g., in the form of high-pressure nozzles) can be integrated into the portal washing installation 1. The washing portal can be movable on at least one and typically two running rails in a longitudinal direction of the portal washing installation 1.

The vehicle washing installation 1 and the individual working units exchange data with the control unit 10. To this end, the vehicle washing installation 1 has a control module 19 provided therein which is located inside the portal and is designed to receive and implement control commands B from the control unit 10. For the sake of simplicity, in FIG. 1 the control module 19 inside the washing installation is shown in the portal support 17 on the right. This is intended to represent merely a schematic arrangement. Typically, the control module 19 inside the washing installation will not be mounted in a portal support but instead in a central region (e.g., in an upper segment of the installation). The control unit 19 serves to calculate and output control commands B to supply the control module 19 inside the washing installation with control data and to control said module. To this end, the control commands B include a plurality of control data records for positioning the different brushes and washing units and for setting the rotational speed and the washing agent composition and metering in dependence upon the detected sensor data and/or the user configurations.

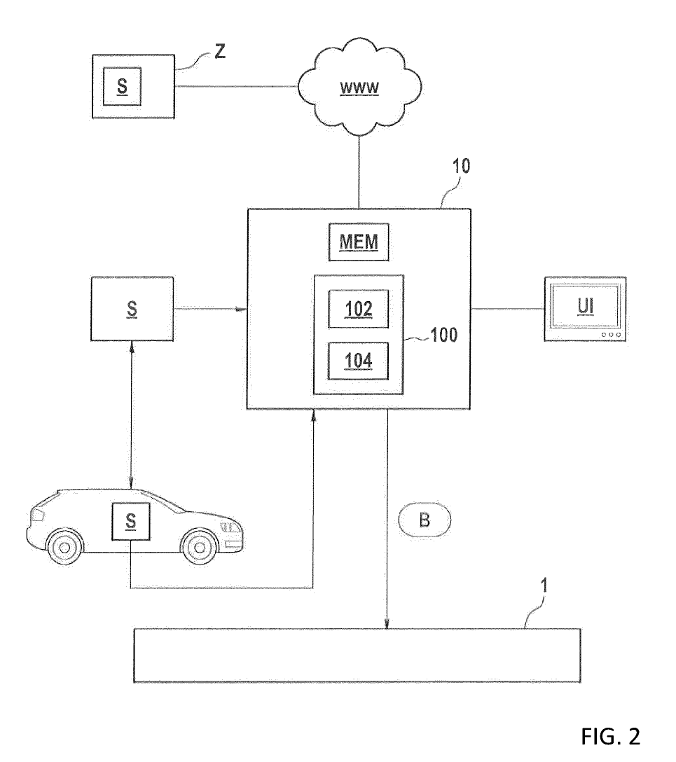

For its part, the control unit 10 comprises a plurality of components and is described in greater detail with reference to FIG. 2. Typically, the control unit 10 comprises a local memory MEM for data storage. The memory MEM can store control commands, executed control commands, detected sensor data, configuration settings and/or optimization criteria. Furthermore, the control unit 10 comprises control logic, in particular, an electronic control logic circuit 100. The control unit 10 exchanges data with the washing installation 1, with a sensor unit S, which are typically not located in or on the washing installation (but instead outside), and with an input and output unit UI which serves as a user interface—typically in the form of an operating terminal—for the user. The control unit 10 can also exchange data with a central server Z, on which sensor data are likewise available. The server Z can be accessible via a public network, such as the Internet www.

The sensor unit S has a multiplicity of sensor-based entities and can comprise different sensors which record different technical measurement values. Typically, the sensors serve to detect sensor signals of the vehicle to be washed in a state prior to the wash, e.g., an amount of dirt by means of optical sensors and moisture or wetness on the surface of the vehicle to be cleaned. In this case, even further variables can be detected depending upon the selected configuration. The sensor unit S is typically designed to detect washing environment conditions (weather, road conditions etc.) and/or vehicle-related signals (amount of dirt, temperature of the vehicle bodywork etc.). To this end, the sensor unit S is designed as a distributed system, as illustrated in FIG. 2. On the one hand, sensors are arranged in one entity of the sensor unit S on the vehicle itself. They are sensors which are mounted on the vehicle temporarily and only for a short period of time prior to the wash. It is also possible for no sensors to be arranged on the vehicle itself but instead for the vehicle to move passively past a sensor unit which is designed to detect signals on the vehicle. This can be e.g., a CCD camera. A further sensor entity can be arranged on the operating terminal UI of the washing installation to detect the washing environment parameters (weather-based signals).

In an exemplary embodiment of the disclosure, the sensor unit S is part of an external system (e.g., a server of a weather service) and the vehicle washing installation 1 in accordance with the disclosure comprises only one interface for reading-in the sensor data of the external sensor system and configuration data records input by the user via the user interface. The sensor signals can thus be read-in and processed by one or a plurality of remote computer-based units, as illustrated at the top of FIG. 2, via the Internet www. In addition, the configuration settings of the user are calculated when configuring the washing program sections.

For instance, it is possible inter alia to configure which of the units installed in the vehicle washing installation 1 are to be operated for the washing procedure (e.g., only the pre-cleaning units and not a drying unit) and/or how or in which mode and in which sequence they are to be operated. The following configurations are e.g., possible:
which cleaning product is to be loaded into the unit,
in which form is the cleaning product to be applied: e.g., foamed or not foamed. If the product is applied e.g., in foamed form, then the surface adhesion is increased. In turn, this influences the exposure time (in this case: a longer exposure time),
how long shall the exposure time of the cleaning agent and/or care product be on the vehicle (part),
how high shall the concentration of the cleaning agent and/or care product be. For example, if moisture is detected on the surface of the vehicle, higher metering of a pre-cleaner must be applied in order to obtain specific/desired metering. This is automatically detected and the pre-cleaning unit is activated accordingly.
which water quality shall be used. For instance, it is possible to configure whether high-quality fresh water or lower-quality water from a stored reservoir circuit system or processed water (e.g., in softened form as osmosis water) shall be used.
the quality of cleaning agent and/or care product which is to be used on the washing units (e.g., high quality on a first washing unit (pre-cleaning unit) and lower quality on a second washing unit (wheel rim cleaning units). The individual washing units (brushes, spray systems etc.) which are used in the same washing process can also be configured differently.

The examples of configurations specified above can each be configured individually or can also be used in combination. In an exemplary embodiment, the disclosure relates to the activation of a portal washing installation 1. In this case, the advancing speed of the mobile portal can also be varied over time during the washing procedure. Therefore, it is possible, e.g., to configure a lower portal advancing speed for a first unit and a different speed for a second unit. In a further embodiment of the disclosure, the exposure time of—optionally different—cleaning and/or care substances can be configured. Therefore, the wash can be aligned and defined substantially more flexibly with respect to each application. It is also possible to activate the individual units of the portal washing installation 1 in each case individually, independently and optionally differently and in a dedicated manner.

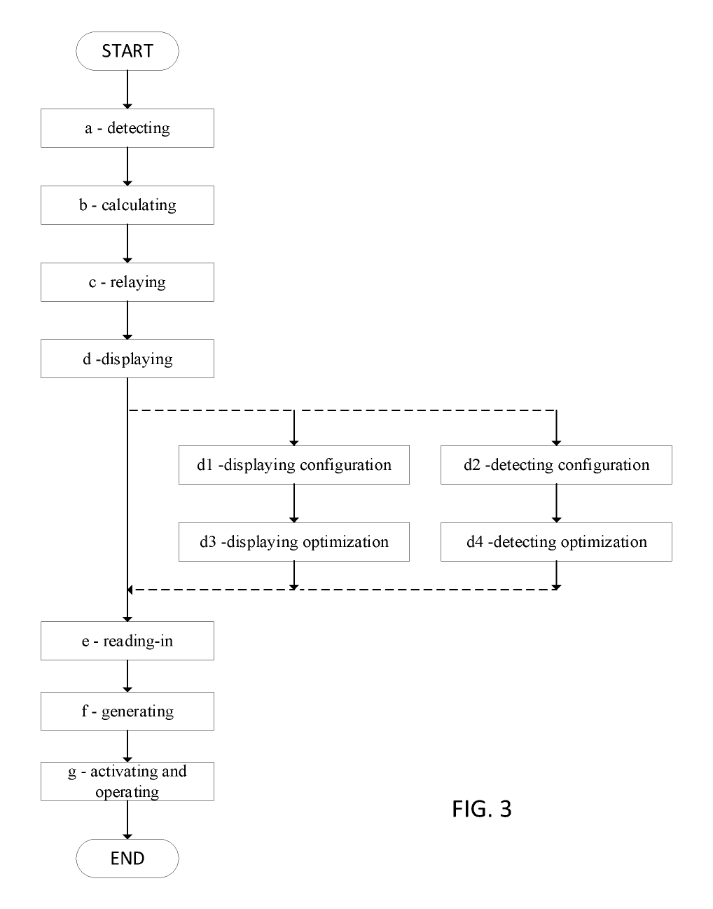

FIG. 3 is a flow diagram in accordance with an exemplary embodiment of the disclosure. After the start of the method, the sensor data are detected in step a. According to an exemplary embodiment, the sensor data can also include the set configurations of the user. For example, it can also be configured that only specific sensor data are to be taken into account when calculating the washing program sections in step b. The calculation of the washing program sections in step b is performed in response to or on the basis of the detected sensor data. Typically, consideration is also given to the user's optimization criteria which the user can input directly prior to the washing procedure via the operating terminal UI for the respective wash or indirectly for a plurality of washes. In the latter case, the user can define that these settings, configurations, and/or optimization criteria shall apply for all of his washes. For this purpose, the inputs are stored in a memory MEM. The calculated washing program sections are relayed in step c to an input and output unit, e.g., in the form of an operating terminal, where they are displayed for the user. Alternatively, the calculated washing program sections can also be transmitted to a previously input address. The address can be, e.g., an e-mail address or an IP address of a terminal of the user, on which an—e.g., browser-based—application is loaded, via which the user can start and execute a computer program to display the calculated washing program sections and select at least one washing program section and read-in the selection signals and transmit the selection signals back to the control unit 10. Step d illustrates the washing program sections calculated by the control unit 10.

As indicated in FIG. 3, the method can now be continued either with step e and the detection of selection signals of the user (for selecting the displayed and calculated washing program sections) or alternatively configuration settings can be displayed in step d1. Then, the user has the opportunity to input specific individual settings and configurations for the scheduled washes (as described above: settings regarding exposure time, quality and/or duration of the substances to be applied, energy consumption or e.g., advancing speed of the portal, etc.). The settings are detected in the form of configuration signals in step d2 and are typically stored. Furthermore, in step d3 it is possible to display optimization criteria (e.g., “energy-saving wash”). In step d4, the optimization signals input by the user are then detected. It is also possible to combine all of the aforementioned options. It is then possible for the user to input on the user interface, which can be formed on an operating terminal, configuration settings, optimization criteria, and selection signals. The input signals are detected in step e.

In an exemplary embodiment of the disclosure, the detected signals are fed to a checksum for consistency. The consistency check is performed typically on the control unit 10. In this case, the detected signals are transmitted to same for checking and, depending upon the result of the check, the result is then communicated to the user on the user interface UI. If an inconsistency is established, the user will be requested to provide a new input, wherein only the permissibly selectable input fields or settings from a displayed menu can be activated. The user is also able to correct the input.

Then, control commands B are calculated in step f on the basis of all inputs of the user—optionally checked for consistency and permissibility—and are used in step g to activate and operate the washing installation. Then, the method can end or can be performed repeatedly for the next user.

Finally, it is noted that the description of the disclosure and the exemplified embodiments are fundamentally to be understood to be non-limiting with respect to a specific physical implementation of the disclosure. All features explained and illustrated in conjunction with individual embodiments of the disclosure can be provided in different combinations in accordance with the disclosure to achieve the advantageous effects thereof at the same time. Therefore, it is, e.g., likewise within the scope of the disclosure, alternatively or cumulatively, to design other interface entities in addition to the input and output unit configured as an operating terminal. For instance, in one exemplary embodiment of the disclosure, provision can be made, e.g., to provide all of the signals, which are to be displayed on the input and output unit, and all of the signals from the user, which are to be detected at that location, additionally also on electronic terminals, such as, smartphones, tablets, or mobile communications devices of the user, which communicate with the control unit 10 via a wireless communications connection (e.g., a mobile communications connection). For this purpose, the user can indicate in the configuration settings the biunique device address to which the user would like to have the signal exchange communicated. Therefore, the user would also be able to control his washing program from home in advance on an interface, such as, a tablet PC. The interfaces can be, e.g., manually operated or stylus-operated operating interfaces. For a person skilled in the art, it is readily understood that the disclosure can be used not just for portal washing installations, but also for tunnel washing installations, the operation of which is controlled in dependence upon user signals on operating terminals.

Furthermore, the components of the sensor-triggered vehicle washing installation 1 can be embodied in a distributed manner on a plurality of physical products. In particular, the vehicle washing installation 1, the sensor unit S, the control unit 10 and/or the operating terminal UI can be configured as a distributed system comprising structurally separate units that exchange data.

The scope of protection of the present disclosure is set by the claims and is not limited by the features explained in the description or shown in the figures.

The foregoing description of the exemplary embodiments of the disclosure illustrates and describes the present invention. Additionally, the disclosure shows and describes only the exemplary embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The term “comprising” (and its grammatical variations) as used herein is used in the inclusive sense of “having” or “including” and not in the exclusive sense of “consisting only of.” The terms “a” and “the” as used herein are understood to encompass the plural as well as the singular.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

### REFERENCE SIGNS

10 control unit
100 control logic, in particular electronic control logic circuit
102 optimization module
104 configuration module
B control command
UI user interface
NW network
S sensor unit
MEM memory
1 vehicle washing installation
11 holding cross beam
12 left lateral vertical washing brush
13 right lateral vertical washing brush
14 left wheel rim brush
15 right wheel rim brush
16 left portal support
17 right portal support
18 horizontal roof washing brush
19 control module inside the washing installation
www Internet
Z central server
a detecting sensor signals
b calculating washing program sections
c relaying the calculated washing program sections to a user interface
d displaying the calculated washing program sections on the user interface
d1 displaying configuration settings
d2 detecting configuration settings
d3 displaying optimization criteria
d4 detecting optimization signals
e reading-in selection signals
f generating control commands
g activating and operating the vehicle washing installation on the basis of control commands

1. A vehicle washing installation comprising:
a control unit;
a sensor unit; and
an input and output unit;
wherein the control unit has an interface to the sensor unit, via which a sensor signal is read-in and relayed to the control unit that is configured to calculate a control command;
the control unit being configured to respond to a received sensor signal by calculating a washing program section, to control the vehicle washing installation with control logic, and to provide the washing program section for display on the input and output unit;
the input and output unit being configured:
as a user interface,
to output the washing program section calculated by the control unit,
to detect a selection signal for selecting the washing program section displayed on the input and output unit, and
to control the vehicle washing installation.

2. The vehicle washing installation as claimed in claim 1, wherein the sensor unit is arranged outside the vehicle washing installation and not on a component of the vehicle washing installation.

3. The vehicle washing installation as claimed in claim 1, comprising a plurality of units, wherein the units are activated in a modular and dedicated manner by the control unit.

4. A control unit for activating a vehicle washing installation, the control unit being configured to:
exchange data with the input and output unit, which is configured as a user interface;
wherein the input and output unit is configured to display a host of washing programs with washing program sections and to detect a selection of the displayed washing program sections;
wherein the control unit is configured to calculate, from the detected selection, a control command for activating a vehicle washing installation, and
wherein the control unit is configured to receive a sensor signal from a sensor unit and, in response to the received sensor signals, is configured to calculate a washing program section with a control logic and to display the washing program section on the input and output unit.

5. The control unit as claimed in claim 4, wherein the control logic of the control unit is configured to determine, from the received sensor signal of the sensor unit, an ACTUAL-state and to compare the ACTUAL-state to a reference state stored in a memory to perform a state-dependent calculation of the washing program section.

6. The control unit as claimed in claim 4, further comprising:
an optimization module configured to optimize the calculated washing program section based on an optimization criterium.

7. The control unit as claimed in claim 4, wherein the control logic further comprises:
a configuration module configured to read-in a configuration setting that is detected on the input and output unit.

8. The control unit as claimed in claim 4, wherein the sensor unit is configured in a distributed manner and comprises:
a plurality of sensors on different components; or
the sensor unit is configured to exchange data with external sensors; or
the sensor unit comprises the plurality of sensors on different components and the sensor unit is configured to exchange data with external sensors.

9. The control unit as claimed in claim 4, wherein the sensor unit comprises:
sensors on a vehicle or external sensors for detecting technical ambient parameters, which detect a physical measurement value of the vehicle or a washing environment.

10. The control unit as claimed in claim 4, further comprising:
a switch configured to activated, deactivate, or activate and deactivate the control unit.

11. The control unit as claimed in claim 4, further comprising:
a memory configured to store the washing program section calculated by the control logic.

12. A method of activating a vehicle washing installation comprising:
detecting a sensor signal,
calculating a washing program section in response to the detected sensor signal,
relaying the calculated washing program section to an input and output unit for display,
reading-in a selection signal for selecting the washing program section displayed on the input and output unit, and
generating a control command to activate the vehicle washing installation on the basis of the read-in selection signal.

13. The method as claimed in claim 12, further comprising:
detecting the selection signal on the input and output unit,
wherein the selection signal includes a configuration setting or an optimization criterium for a washing process of the vehicle washing installation, and
wherein the control command is generated in response to the detected selection signal.

14. The method as claimed in claim 12, wherein an individual unit of the vehicle washing installation is activated in a dedicated manner and with a unit-specific control command.

15. The method as claimed in claim 12, wherein in response to the detected sensor signals the detected sensor signals are output on the input and output unit.

16. The method as claimed in claim 12, wherein the executed control command is monitored during operation of the vehicle washing installation and is fed to a calculation unit, which automatically calculates a cost of the washing process and relays the cost to an output unit.

17. A computer program product stored on a non-transitory computer readable storage medium includes software routines that when executed on a digital computer perform the method according to claim 12.

18. The method as claimed in claim 14, wherein the individual unit of the vehicle washing installation is also activated differently.

19. The control unit as claimed in claim 6, wherein the optimization criterium is at least one of metering of a cleaning agent, water consumption, or energy consumption.

20. The control unit as claimed in claim 9, wherein the sensor of the vehicle or the washing environment is at least one of a temperature sensor, a time sensor, an air humidity sensor, a sensor configured to detect a vehicle size, or a sensor configured to detect an amount of dirt on the vehicle.
